(19) United States
(12) Patent Application Publication
(10) Pub. No.: US 2008/0059656 A1
(43) Pub. Date: Mar. 6, 2008

(54) Content synchronization among associated computing devices

(76) Inventors: Bassam A. Saliba, Sammamish, WA (US); Saed H. Nashef, Redmond, WA (US); John Yii, Newcastle, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/514,435

(22) Filed: Aug. 31, 2006

(51) Int. Cl. G06F 15/16

(52) U.S. Cl. 709/248; 709/231

(57) ABSTRACT

Methods, apparatuses, and articles for synchronizing contents of associated computing devices are described herein. In various embodiments, the method includes receiving, by a first computing device, from a shared server, a notification that content on a second computing device has been created or updated. The first computing device may also request at least a first portion of the created/updated content from the second computing device to contribute to synchronizing the first and second computing devices with respect to the content. Further, the first computing device may receive at least a second portion of the created/updated content from the second computing device to effectuate said contribution to synchronizing the first and second computing devices with respect to the content.

### FIELD OF THE INVENTION

The present invention relates to the field of data processing, in particular, to methods and apparatuses for synchronizing content among associated computing devices.

### BACKGROUND OF THE INVENTION

Advances in networking, processor speed, and storage devices have made possible the sharing of content between computer systems. Often, a given user will have a plurality of computer systems, such as a work laptop and a home desktop computer, and may wish both systems to have the same contents. Traditionally, the contents of the computer systems are locally stored resources that have been created and received by the computer systems, such as documents, photos, audio and video files, and databases. Transfers of such resources between computer systems require the use of a storage device, such as a floppy diskette, CD-ROM, or thumb drive, or the use of a network to which both computer systems are coupled. The user and his or her computer systems, however, often lack current knowledge of all the resources on each system. Accordingly, traditional synchronizing of computer system content is often over-inclusive or under-inclusive.

In an alternate approach, to allow the users to access any of their resources at any time, regardless of which computer system is being used, all resources may have to be stored on a remote storage server. Thereafter, any system having a network connection to the storage server may access a desired resource. However, if the computer system lacks a network connection to the storage server, none of the desired resources will be currently accessible.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of various embodiments of the present invention, including computing devices equipped with content synchronizing agents hand a server having a list of the contents of the computing devices;

FIGS. 2a-2b illustrate flow chart views of selected operations of the methods of various embodiments of the present invention, including notifying a server of created/updated content and synchronizing content with other computing devices; and

FIG. 3 is a block diagram illustrating an example computing device suitable for use to practice the client computing device and/or server aspects of the present invention, in accordance with various embodiments.

### DETAILED DESCRIPTION OF EMBODIMENTS OF THE INVENTION

Illustrative embodiments of the present invention include, but are not limited to, methods and apparatuses for synchronizing contents among associated computing devices. In various embodiments, a first computing device receives from a shared server, a notification that content on a second computing device has been created or updated. In various embodiments, the first computing device may also request at least a first portion of the created/updated content from the second computing device to contribute to synchronizing the first and second computing devices with respect to the content. Further, in some embodiments, the first computing device may receive at least a second portion of the created/updated content from the second computing device to effectuate said contribution to synchronizing the first and second computing devices with respect to the content. In one embodiment, the server may have a list of contents representing a union of content on both the first and second computing devices that is updated by those devices as new content is created/updated on either computing device.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(B) or (A B)”, that is, A is optional.

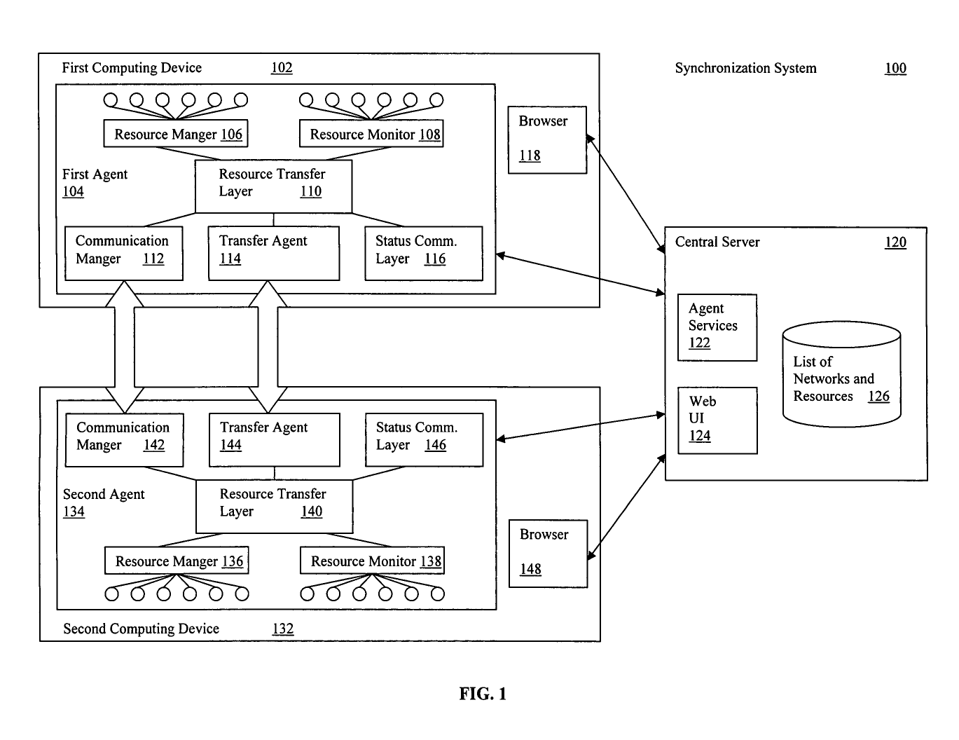

FIG. 1 illustrates an overview of various embodiments of the present invention, including computing devices equipped with content synchronizing agents and a server having a list of the contents of the computing devices. As illustrated, a synchronization system 100 may include a server 120 and two or more client computing devices, such as first computing device 102 and second computing device 132 coupled with each other via a networking fabric (not shown). The coupling to the networking fabric may be persistent or intermittent. The computing devices 102/132 may download an agent 104/134 from the server 120 (or otherwise have agent 104/134 installed), the agents 104/134 equipped to notify the server 120 of newly created and updated content of the computing devices 102/132, to receive notification from server 120 of created/updated content on the other computing device 102/132, and to establish a peer-to-peer connection between first computing device 102 and second computing device 132 to synchronize content between the computing devices 102/132. Accordingly, synchronization system 100 may achieve the synchronization of computing device 102/132 content through the interactions of the computing devices 102/132 with a server 120 and with each other, in the above generally described manner, to be described in more detail below.

In various embodiments, the computing devices 102/132 further comprise browsers 118/148, in addition to the downloaded agents 104/134. The browsers 118/148 may facilitate a user of a computing device 104/134 in establishing a personal network or cluster of associated computing devices with server 120, by establishing a user account, listing other computing devices 102/132 of the user to be associated under the user account, and in downloading an agent 104/134 to each of the associated computing devices. To facilitate the user in achieving these operations, the server 120, in various embodiments, may include a web user interface 124 that the user may receive through browser 118/148; a list of networks and resources 126 to store a list of all users, the devices 102/132 associated with each user, the resources/content of each computing device 102/132, and other information regarding each resource; and an agent services component 122 equipped to download an agent to computing devices 102/132 and to send notifications to and receive notifications from devices 102/132.

To achieve content synchronization, each agent 104/134 may include a plurality of components. In some embodiments, agents 104/134 may include resource monitors 108/138 with application specific plug-ins to monitor computing device 102/132 resources for the creating, deletion, and moving of new resources and the updating of existing resources, and status communication layers 116/146 equipped to notify an agent services component 122 of the server 120 of the creating/updating of content, and to receive from the agent services component 122 notification that content has been created/updated on another computing device 102/132. Further, the agents 104/134 may also include communication managers 112/142 to establish peer-to-peer connections between computing devices 102/132, protocol specific transfer agents 114/144 (hereinafter “transfer agents 114/144”) to transfer updated/created resources between computing devices 102/132 in accordance with one or more corresponding transfer protocols, and resource managers 106/136 to retrieve and save created/updated content from the other associated computing devices 102/132, through a plurality of application specific plug-ins. To coordinate the above components, each agent 104/134 may further be equipped with a protocol agnostic resource transfer layer 110/140 (hereinafter “resource transfer layer 110/140”).

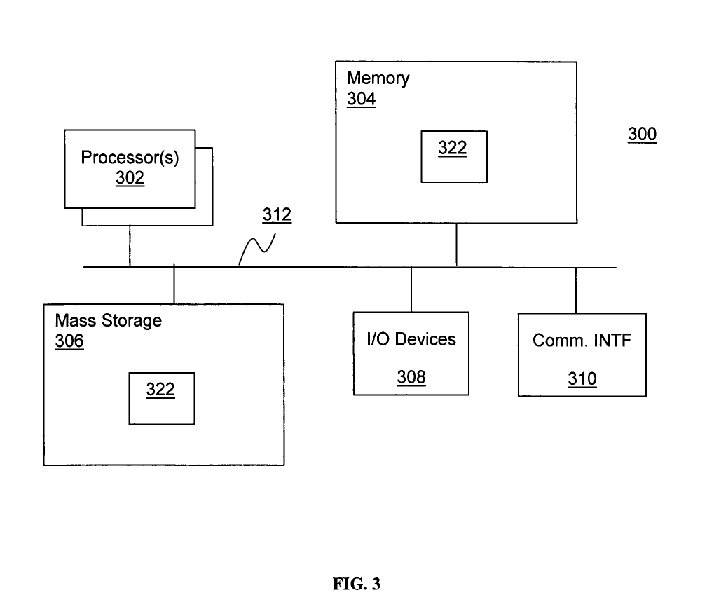

As is shown, the server 120, except for agent services 122, web user interface 124, and list of networks and resources 126, may be any single- or multi-processor computing device known in the art, such as a personal computer (PC), a workstation, a server, a router, a mainframe, a personal digital assistant (PDA), an entertainment center, a set-top box, or a mobile device. Such a server 120 may be implemented on the exemplary computing device illustrated by FIG. 3, which is described in greater detail below. In some embodiments, server 120 may be a web server offering a plurality of web services to computing devices 102/132, such as receiving notifications of created/updated content from various computing devices 102/132, and notifying other associated computing devices 102/132 of the created/updated content of the various reporting associated computing devices 102/132. The server 120 may additionally comprise one or more networking interfaces (not shown) coupling the server 120 to a networking fabric (not shown). The networking interfaces may be of any sort known in the art, such as Ethernet, Bluetooth, WiFi (802.11), or 3G interfaces, providing connectivity to a wired or wireless networking fabric.

In some embodiments, server 120 may comprise a web user interface 124. Web user interface 124 may include one or more web pages of HTML, web pages of scripting languages such as ECMAScript, and/or web pages of compiled languages such as C++. The one or more web pages may provide, in some embodiments, a graphic user interface with various graphic facilities, displays of information, buttons corresponding to actions, and forms facilitating users in inputting information. As such, web user interface 124 may be similar to other web pages known in the art. Also, among its graphic facilities, web user interface 124 may provide facilities allowing a user to create/define a “network” or a “cluster” of that user's “associated” computing devices 102/132 (which may also be referred to as related computing devices 102/132). The associated computing devices 102/132 may include computing devices of the user as well as computing devices of a second user, which may appear, from the server 120's and network/cluster's perspective to be computing device 102/132 of the user. Such a network/cluster (hereinafter, “network”), in various embodiments, may require a unique user name or email, a password, and other information of the sort often required to open a web services account. Additionally, web user interface 124 may provide facilities to add or delete computing devices 102/132 to the user's network, facilities to view resources of the user's computing devices 102/132, facilities to view all the user's resources combined together to view a single master list of all the user's content regardless of their distributed physical storage, facilities to delete a listed resource from all of the computing devices 102/132 belonging to the user's network, and facilities to request downloading of an agent 104/134 to a computing device 102/132 of the user's network. In alternate embodiments, rather than providing downloading request facilities, server 120 may automatically download an agent 104/134 to each computing device 102/132 as it is added to the network, immediately or, if not connected, upon connection of the computing device 102/132 to the networking fabric.

As illustrated by FIG. 1, server 120 may comprise a list of the defined networks and their computing devices and resources 126. The list 126 may be stored employing any sort of data organization/structure, such as a relational database, and may include normalized and/or denormalized data. In alternate embodiments, list 126 may simply be a file capable of storing data. Among the data stored, list 126 may include information about users that have created/define the networks to server 120 through web user interface 124. In one embodiment, each user may be represented by an email address. Associated with each user may be a plurality of computing devices 102/132. In some embodiments, each computing device 102/132 listed on server 120 may have an associated flag indicating whether an agent 104/134 has been downloaded to the computing device 102/132, a field indicating whether the computing device 102/132 is online (connected to the networking fabric), and, if offline, a time in a time field indicating when the computing device 102/132 went offline. Also, for each computing device 102/132 listed in the server 120, information about one or more resources of that computing device 102/132 may be stored by list 126. Among the information stored about each resource may be a name of the resource, a path to the resource (i.e., C:\Program Files\Clock\gadgets.doc), a counter indicating the number of created/updated notifications associated with the resource received by server 120, and a time the latest notification regarding the resource was received. List 126 may be automatically populated with information regarding the resources of a computing device 102/132 in the course of installing an agent 104/134 on that device 102/132.

In some embodiments, rather than being stored on server 120, list 126 may reside on one or more other servers connected to server 120 through a networking fabric. The other server(s), may, in one embodiment, be a database or file server.

In various embodiments, server 120 may further include an agent services component 122 (hereinafter “Agent services 122”). Agent services 122 may be any sort of process, sub-process, or module equipped to receive notifications from computing devices 102/132 and to send notifications to those devices. Upon receiving a created/delete/move/updated content notification from an agent 104/134, agent services 122 may determine if the resource that is the subject of the notification is part of list 126. If the resource is not mentioned in the list 126, agent services 122 may add the information regarding the resource to list 126, including a name of the resource and a path, and may set the notification counter at “1” and set the time to the time at which the notification was received. If the resource is mentioned in list 126, agent services 122 may increment the counter associated with the resource and may set the time to the time at which the notification was received.

Upon updating the list 126, agent services 122 may query the list 126 to determine the other computing devices 102/132 associated with the user of the notification-sending computing device 102/132, and may send a notification to those other associated computing devices 102/132. In some embodiments, the notification may include the name of the created/updated/deleted/moved file, its path, and the computing device 102/132 having the latest version. The agent services 122 may also query the list 126 to determine which of the other computing devices 102/132 are online, and may only send the notification to computing devices 102/132 currently online. Computing devices 102/132 that are offline may then have their agents 104/134 check in with agent services 122 upon coming online. Agent services 122 may then determine the time the computing device 102/132 last went offline, and may query list 126 for resources associated with the user that have a last updated time subsequent to the time computing device 102/132 went offline. Agent services 122 may then notify the now online computing device 102/132 of these resources, including the names of the resources, their paths, and the computing devices 102/132 having the latest versions of the resources.

Further, in various embodiments, agent services 122 may also be equipped to download agents 104/134 to computing devices 102/132. The agent services 122 may perform this operation automatically each time a computing device 102/132 is added to list 126. Upon downloading an agent 104/134 to a computing device 102/132, agent services 122 may receive a list of resources on the device 102/132 from the installing agent 104/134, and may query the list 126 to determine if any of the named resources is present in the list 126. Agent services 122 may then return the names and times of last update of each resource present on both new computing device 102/132 and list 126 to the newly associated computing device 126, facilitating the installing agent 104/134 in determining the most recent version. The installing agent 104/134 may then notify agent services 122 of resources of the computing device 102/132 that are either unique to device 102/132 or are more recent versions of a resource than the version listed in list 126. Agent services 122 may then update list 126 to include those resources, and notify the other computing devices 102/132 of the new resources and/or newer versions of the resources. In some embodiments, agent services 122 may also, prior to updating the list 126, notify the newly associated computing device 102/132 of the resources in list 126 associated with the user of the newly associated computing device 102/132.

In one embodiment, agent services 122 may also receive a delete resource command from web user interface 124. Agent services 122 may then delete the resource from list 126 and send a command to the agents 104/134 of computing devices 102/132 to delete their copies of the resource.

In some embodiments, the server 120 and computing devices 102/132 may be coupled to a networking fabric (not shown), which in some embodiments may provide access for the server 120 to the computing devices 102/132, and visa versa, via the Internet, a private wide area network (WAN), and/or a private local area network (LAN). Further, the connections between the server 120 and the various computing devices 102/132 of the networking fabric may be of any sort known in the art, such as transmission control protocol/Internet protocol (TCP/IP) connections or asynchronous transfer mode (ATM) virtual connections.

As illustrated, synchronization system 100 may further include a plurality of computing devices, such as first computing device 102 and second computing device 132. The computing devices 102/132, except for agents 104/134 and the various components of the agents 104/134 (described below), may be any single- or multi-processor computing device, such as a personal computer (PC), a workstation, a server, a router, a mainframe, a personal digital assistant (PDA), an entertainment center, a set-top box, or a mobile device. Such computing devices 102/132 may illustrated by the exemplary computing device shown in FIG. 4, which is described in greater detail below. The computing devices 102/132 may comprise one or more networking interfaces (not shown) connecting the server 120 to a networking fabric (not shown). The networking interfaces may be of any sort known in the art, such as Ethernet, Bluetooth, WiFi (802.11), or 3G interfaces, providing connectivity to a wired or wireless networking fabric. Additionally, the computing devices 102/132 may include browsers 118/148 and agents 104/134.

In some embodiments, browsers 118/148 may be any sort of web browsers known in the art. Browsers 118/148 may be capable of accessing, retrieving, and viewing contents such as web pages residing locally or on a remote computing device, capable of facilitating user interaction with the viewed contents, and capable of submitting to the content providing system/device/process various user inputs to the content. For example, browsers 118/148 may allow users of computing devices 102/132 to view and interact with the web user interface 124 of server 120.

As is shown, the computing devices 102/132 may include agents 104/134. An agent 104/134 may monitor computing device 102/132 content for the creation of new resources and the updating of existing resources, may send notifications of such created/updated content, may receive such notifications regarding created/updated contents on other associated computing devices 102/132, and may send/receive the created/updated content to effectuate the synchronization of computing devices 102/132. In various embodiments, agents 104/134 may include a plurality of components that may be sub-processes of the agent 104/134 process, such as resource managers 106/136, resource monitors 108/138, resource transfer layers 110/140, communication managers 112/142, transfer agents 114/144, and status communication layers 116/146. While shown and described as separate sub-processes, each of the above components may be combined with any one or more of the other components to form a sub-process, or may consist in itself of multiple sub-processes.

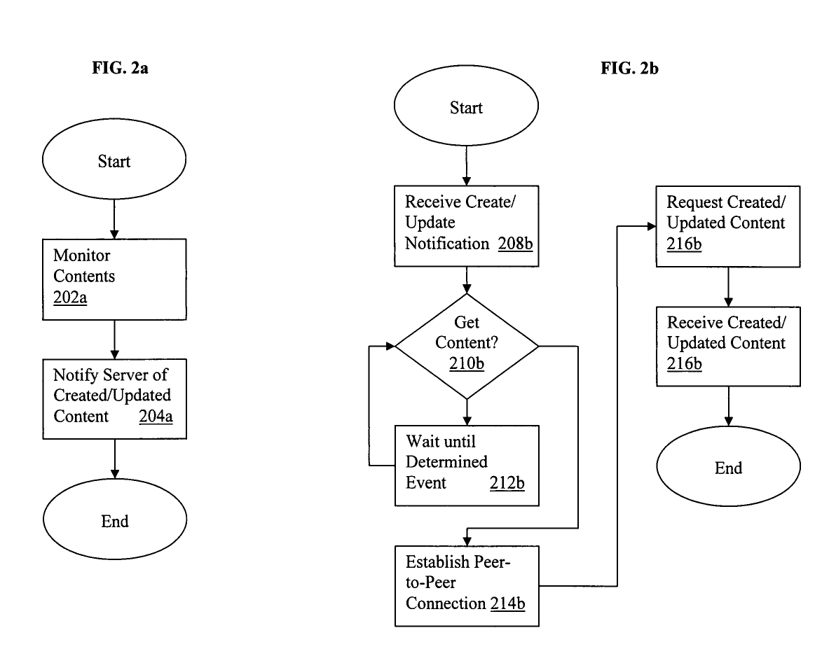

As described in detail above, an agent 104/134 may be downloaded to a computing device 102/132 from an agent services component 122 of a central server 120. Upon downloading the agent 104/134, installation of the agent 104/134 may begin immediately or may await a user input requesting installation. In the process of installing (or post installation), agent 104/134 may determine all the resources present on the computing device 102/132, and may notify the server 120 through its agent services 122 of the resources. The installing agent 104/134 may then receive in return a list of resources that are both present on the computing device 102/132 of the installing agent 104/134 and present on the list 126 of the server 120. The return list may include for each resource a name and a time at which the resource was last updated. The installing agent 104/134 may then compare the time of last update provided by the server 120 with the time of last update of the resource stored on the computing device 102/132. If the stored resource was last updated before the time of last update received from server 120, then the stored version will be considered an “older version”, and will be removed from the first list of computing device 102/132 resources initially sent to server 120. After removing the “older versions” from the first list, the installing agent 104/134 may resend the list, minus the “older versions”, to the server 120, and may then complete installation. Immediately upon completing installation (and subsequently, during operation), agent 104/134 may receive notification of the resources present on the other computing devices 102/132 from server 120, and may proceed to effectuate content synchronization with the other computing devices 102/132 in the manner described below in reference to the agent 104/134, illustrated in FIGS. 2a-2b, and described below.

In various embodiments, each agent 104/134 may include a resource transfer layer 110/140. The resource transfer layer 110/140 may be any sort of process or sub-process, such as a sub-process of the agent 104/134, and may serve as the management component of agent 104/134, coordinating the operations of the resource manager 106/136, the resource monitor 108/138, the communication manager 112/142, the transfer agents 114/144, and/or the status communication layer 116/146. For example, resource transfer layer 110/140 may receive a notification from the resource monitor 108/138 each time a resource of the computing device 102/132 is created/updated (or may receive the notifications in batches, periodically). The notification may include the name of the resource and a path from which the resource can be retrieved. Upon receiving the notification (substantially concurrently or anytime thereafter), the resource transfer layer 110/140 may request that the resource manager 106/136 retrieve the created/updated resource through one of its application specific plug-ins. The resource transfer layer 110/140 may then receive the retrieved resource from the resource manager 106/136, and may store the resource in a memory structure of the resource transfer layer 110/140 to facilitate quick dispersement to other computing devices 102/132 requesting the created/updated content. Next, the resource transfer layer 110/140 may notify the status communication layer 116/146 of the created/updated resource, and may direct the status communication layer 116/146 to send a notification to the server 120 of the created/updated content, including the name of the resource and its path.

In some embodiments, the resource transfer layer 110/140 may further receive notification from the status communication layer 116/146 upon the status communication layer's receipt of notification from the server 120 that a resource on another computing device 102/132 has been created/updated. The resource transfer layer 110/140 may then, in one embodiment, immediately direct the communication manager 112/142 to establish a peer-to-peer network connection with the other computing device 102/132. In an alternate embodiment, the resource transfer layer 110/140 may graphically notify a user of the created/updated resource, and ask the user whether the created/updated resource should be retrieved (and optionally, if the resource is to be retrieved, whether the resource is to be retrieved immediately or subsequently). Such a graphic notification may be achieved, for example, through a pop-up window. In yet another embodiment, the resource transfer layer 110/140 may first determine, through the communication manager 112/142, if the other computing device 102/132 is connected to the networking fabric. If not connected, the resource transfer layer 110/140 may wait a pre-determined period of time and check again, until the other computing device 102/132 is connected. Once the other computing device is connected, and/or upon receiving user direction to retrieve the resource, the resource transfer layer 110/140 may direct the communication manager 112/142 to establish a peer-to-peer network connection with the other computing device 102/132. After a connection has been established, the other resource transfer layer 110/140 of the other computing device 102/132, having the created/updated resource stored in a memory structure, may provide the resource to the resource transfer layer 110/140 through the respective transfer agent 114/144 of each agent 104/134. The resource transfer layer 110/140, upon receiving the resource through its transfer agent 114/144, may provide the resource to its resource manager 106/136, and may direct the resource manager 106/136 to save the resource through its application specific plug-ins.

While the above description makes reference to the resource transfer layer 110/140 directing the establishment of one peer-to-peer connection to synchronize content, in other embodiments the resource transfer layer 110/140 may be a multi-thread sub-process creating a thread for each new peer-to-peer connection, allowing the resource transfer layer 110/140 to manage for the agent 104/134 multiple content synchronizing connections with multiple other computing devices 102/132.

As illustrated, the resource monitor 108/138 of the agent 104/134 may include of plurality of application specific plug-ins to monitor the resources of computing device 102/132 for the creating and updating of content. In one embodiment, the resource monitor 108/138 may be event triggered. For example, a Microsoft Outlook application plug-in monitoring the receiving, creation or updating of email messages may cause the resource monitor 108/138 to notify the resource transfer layer 110/140 of a resource creation/update each time an email is received or modified, providing the resource transfer layer 110/140 with the resource ID (email GUID) of the created/updated content. In other embodiments, each time a resource is opened in an application editor, the application specific plug-in associated with the application editor may create a separate resource to which edits are appended. For example, if a Word document is edited, a separate file may be opened containing edited portions of the Word document, metadata comprising the locations of the edited portions within the Word document, as well as a code indicating to a resource manager 106/136 of a recipient computing device 102/132 that the resource contains only updates to the created/updated resource. In another example, if the resource is a database comprised of tables, the application specific plug-in of the resource monitor 108/138 may divide the database into logical entities, such as tables or fields, and may create a resource comprised of the updates to a database, such as new tables, new fields in existing tables, metadata describing the relationships of the new logical entities to the logical entities of the previous version, and a code indicating to a resource manager 106/136 of a recipient computing device 102/132 that the resource contains only logical entity updates. Upon detecting an event, such as the saving of the edited Word document or modifying the database, the resource monitor 108/138 may save and close the created resource comprised of the updates, saving the resource in a directory of the agent 104/134 and providing it with the same name as the complete, updated resource. The resource monitor may then provide to the resource transfer layer 110/140 the name and location of the generated resource with the updates rather than information regarding the complete, updated resource.

In various embodiments, the status communication layer 116/146 may be adapted to initiate a TCP/IP communication connection with the server 120, either by itself, acting as a TCP/IP stack initiating a connection through the networking interface of the computing device 102/132, or through a TCP/IP stack of the computing device 102/132, the TCP/IP stack establishing the connection through the networking interface of the computing device 102/132. The status communication layer 116/146, may, in some embodiments, initiate such a connection with the server 120 each time the computing device 102/132 comes online, facilitating the status communication layer 116/146 in listening to the server 120 for update notifications. In other embodiments, the status communication layer 116/146 may only initiate such a connection upon receiving a command from the resource transfer layer 110/140 to notify the server 120 of created/updated content. Upon first connecting to the server 120, the status communication layer 116/146 may send a request to the agent services component 122 of the server 120 for notifications of all created/updated contents that have been created/updated on other computing devices 102/132 since computing device 102/132 went offline. Upon receiving the return notifications from the server 120, or other created/updated content notifications from the server, the status communication layer may notify the resource transfer layer 110/140 of the server 120 notification.

As is shown, the communication manager 112/142 may, at the direction of the resource transfer layer 110/140, initiate a TCP/IP peer-to-peer connection between the two agents 104/134 of the computing devices 102/132. In some embodiments, communication manager 112/142 may initiate the connection itself, while in other embodiments, the communication manager 112/142 may simply request the network connection through the TCP/IP stack of the computing device 102/132, the TCP/IP stack establishing the connection through the networking interface of the computing device 102/132. Thus, communication manager 112/142 may either act as a TCP/IP stack itself, or communicate with the TCP/IP stack of the computing device 102/132. The communication manager 112/142 may receive the address of the other computing device 102/132 (for example, its IP address) from the resource transfer layer 110/140, which in turn may have received the address as a part of the created/updated content notification received from server 120 through the status communication layer 116/146. If a connection is unavailable, the communication manager 112/142 may notify the resource transfer layer 110/140 and try again at a pre-determined or dynamically determined later time. Once a connection has been established, the communication manager 112/142 may communicate a request for the created/updated content from the resource transfer layer 110/140 to the other resource transfer layer 110/140 that has the created/updated content stored in a memory structure. The other resource transfer layer 110/140 may then provide the resource through one of its transfer agents 114/144, if the requesting computing device 102/132 has one of the same transfer agents 114/144. The negotiation of the transfer agents 114/144 between the resource transfer layers 110/140 may also be achieved by communicating through the communication managers 112/142. The transfer agents 114/144 may be adapted to support a variety of protocols, such as BitTorrent and the File Transfer Protocol (FTP).

In various embodiments, the resource manager 106/136 may retrieve and save resources at the request of the resource transfer layer 110/140, through its application specific plug-ins. The resource manager 106/136 may comprise a plurality of plug-ins for at least some of the applications of the computing device 102/132, and may even include plug-ins for applications not present on the computing device 102/132. In one embodiment, the resource manager 106/136 may also include one or more type translators, for example, to translate a Word document on a first device which may be a PC machine into a different application type understandable on a second device such as a Macintosh or a Linux server. The resource manager 106/136 may be equipped to retrieve a resource at the request of the resource transfer layer 110/140, through its application specific plug-ins, and to provide the requested resource to the resource transfer layer 110/140. The resource manager 106/136 may be further equipped, in some embodiments, to save a resource at the request of the resource transfer layer 110/140, using its application specific plug-ins. If the resource is of a type for which the resource manager 106/136 lacks a plug-in, the resource manager 106/136 may make use of an application type translator to translate the resource to an application type for which the resource manager 106/136 does have a plug-in, at which point the resource manager 106/136 may save the resource using the plug-in. In one embodiment, the resource manager 106/136 may be equipped to scan the resource to determine if the resource contains a code indicating that the resource only contains updates to a document present on the computing device 102/132. If such a code is found, the resource manager 106/136 may open both the document and the resource having updates to the document, and may insert, through the plug-in associated with the document and resource, the updates at the places in the document indicated by metadata contained in the resource. The now updated document may then be saved by the resource manager 106/136.

FIGS. 2a-2b illustrate flow chart views of selected operations of the methods of various embodiments of the present invention, including notifying a server of created/updated content and synchronizing content with other computing devices.

FIG. 2a illustrates a flowchart of selected operations performed by an agent of a computing device to monitor device resources/contents and to notify a central server of newly created/updated resources. As illustrated, an agent of a computing device may monitor the resources of the computing device and notify a server of created/updated resources, blocks 202a-204a. As discussed earlier, in various embodiments, the agent of the computing device may include a resource monitor with application specific plug-ins to monitor the creating and updating of computing device contents of various resource types, block 202a. The resource monitor may be event triggered and may track, for example, “save” operations of documents or other files. Upon noting a triggering event, the resource monitor may notify a resource transfer layer of the agent of the name of the resource triggering the event and its path. The resource transfer layer may then retrieve the file for future synchronization operations (described below in reference to FIG. 2b) and may notify a status communication layer of the agent of the name and path of the created/updated event triggering resource. The status communication layer may then notify a central server of the created/updated content, block 204a. In some embodiments, the computing device may be connected to the server by a networking fabric and may use the HTTP protocol to communicate with the server. To notify the server of the created/updated content, the status communication layer may send a message to an agent services component of the server, which may store information regarding the updated resource in a list of created/updated resources maintained by the server, the list of the server including at least an entry for the user of the computing device, for other computing devices of the user, and for resources on each of the user's computing devices. The agent of the computing device may perform these monitoring and notifying operations for each newly detected resource creation/update event.

FIG. 2b illustrates a flowchart of selected operations performed by an agent of a computing device to receive a notification from a server of a created/updated resource on another computing device, and to synchronize content with that other computing device. As illustrated, a computing device may receive a notification from a server that content has been created/updated on another computing device, and may determine if it is an appropriate time to synchronize content with that other device, blocks 208b-210b. More specifically, in various embodiments, a status communication layer of the agent may receive the notification from an agent services component of the server, block 208b. The server may be connected to the computing device through a networking fabric, and may communicate with the computing device using the HTTP protocol. Upon receiving a created/updated content notification from the computing device with the created/updated content, the agent services component may determine the other computing devices of the user having the device with the created/updated content, and may notify the other devices through the status communication layers of the agents, block 208b. Upon receiving the notification, the status communication layer may inform a resource transfer layer of the agent of the created/updated content on the other computing device. The resource transfer layer of the particular computing device may then determine, block 210b, whether it should immediately retrieve the created/updated content, or wait for a pre-determined event or dynamically determined period of wait time, block 212b. In some embodiments, the resource transfer layer may be set to automatically retrieve the created/updated content, while in other embodiments, the resource transfer layer may first determine whether the other computing device having the created/updated content is online, and if offline, may wait for the other computing device to come online before seeking to retrieve the content.

As is further illustrated, upon determining to retrieve the content, the agent of the computing device may establish a peer-to-peer connection with the other computing device having the created/updated content, may request the created/updated content from the other computing device, and may receive and save the created/updated content from the other computing device, blocks 214b-218b. The operations may be performed through the earlier described transfer protocol specific transfer agents, with or without the employment of a protocol agnostic resource transfer layer in controlling the transfers.

More specifically, in some embodiments, the resource transfer layer of the agent, upon determining to retrieve the created/updated content, may direct a communication manager of the agent to establish a peer-to-peer network communication connection with the computing device having the created/updated content, block 214b. The specific endpoints of the connection may be the agents of the computing devices. Upon establishing the connection, the resource transfer layer of the computing device may request, through its communication manager, the created/updated resource from the other computing device, block 216b. The resources transfer layer of the other computing device's agent may receive the request through its own communication manager. Upon receiving the request, the resource transfer layer of the other computing device, having already retrieved the created/updated resource (see FIG. 2a and the description above in reference to that figure), may provide the created/updated resource (or, if updated, may provide only the differences comprising the update) to the computing device requesting the resource. To provide the created/updated resource, the resource transfer layer of the other computing device may transfer the resource to the requesting computing device via one or more transfer protocols of its agent, such as the BitTorrent protocol or the File Transfer Protocol (FTP). The requesting computing device may then receive the resource via one or more of its own transfer protocols, block 218b. Upon receiving the created/updated resource, the resource transfer layer of the agent of the receiving computing device may direct a resource manager of the agent to save the received resource through one or more of its application specific plug-ins.

The agent of the computing device may perform these notice receiving, connection establishing, content requesting, and content receiving operations, blocks 208b-218b, for each notice of created/updated content received.

FIG. 3 is a block diagram illustrating an example computing device suitable for use to practice the client computing device and/or server aspects of the present invention, in accordance with various embodiments. As shown, computing system/device 300 includes one or more processors 302, and system memory 304. Additionally, computing system/device 300 includes mass storage devices 306 (such as diskette, hard drive, CDROM and so forth), input/output devices 308 (such as keyboard, cursor control and so forth) and communication interfaces 310 (such as network interface cards, modems and so forth). The elements are coupled to each other via system bus 312, which represents one or more buses. In the case of multiple buses, they are bridged by one or more bus bridges (not shown).

Each of these elements performs its conventional functions known in the art. In particular, system memory 304 and mass storage 306 may be employed to store a working copy and a permanent copy of the programming instructions implementing selected ones or all of the various components of the client computing device and/or server aspects of the present invention, such as the processes illustrated by FIG. 1, herein collectively denoted as 322. The various components may be implemented as assembler instructions supported by processor(s) 302 or high level languages, such as C, that can be compiled into such instructions.

The permanent copy of the programming instructions may be placed into permanent storage 306 in the factory, or in the field, through, for example, a distribution medium (not shown) or through communication interface 310 (from a distribution server (not shown)).

The constitution of these elements 302-312 are known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. Those with skill in the art will readily appreciate that the present invention may be implemented in a very wide variety of embodiments or extended there from. This application is intended to cover any adaptations or variations of the embodiments discussed herein. Therefore, it is manifestly intended that this invention be limited only by the claims and the equivalents thereof.

What is claimed is:

1. A method comprising:
receiving by a first computing device, from a server, a notification that content on a second computing device has been created or updated;
requesting, by the first computing device, at least a first portion of the created/updated content from the second computing device to contribute to synchronizing the first and second computing devices with respect to the content; and
receiving, by the first computing device, at least a second portion of the created/updated content from the second computing device to effectuate said contribution to synchronizing the first and second computing devices with respect to the content.

2. The method of claim 1, wherein the at least first and at least second portions of the created/updated content are the same portion.

3. The method of claim 2, further comprising monitoring, by the first computing device, creating and/or updating of content on the first computing device.

4. The method of claim 2, further comprising notifying, by the first computing device, the server of creating and/or updating of content on the first computing device.

5. The method of claim 1, further comprising establishing, by the first computing device, a peer-to-peer networking connection between the first computing device and the second computing device to facilitate said requesting and receive.

6. The method of claim 5, wherein said receiving is over the peer-to-peer networking connection and in accordance with a transfer protocol selected from a pluggable module which may include a file transfer protocol (FTP), BitTorrent protocol, HTTP, file copy, or other communication protocols.

7. The method of claim 5, further comprising creating, by a resource transfer layer of the first computing device, a thread for each networking connection, enabling the first computing device to establish networking connections with other computing devices in addition to the second computing device.

8. The method of claim 1, wherein the at least second portion of the updated/created content comprises the differences between an updated file and a previous version of the updated file.

9. The method of claim 1, wherein the created/updated content is divided into logical entities, and the at least second portion of the updated/created content comprises the entities of an updated file that were not present in a previous version of that file.

10. The method of claim 1, wherein, upon receiving notification of the created/updated content, the first computing device automatically requests the at least first portion of the created/updated content from the second computing device.

11. The method of claim 1, further comprising saving, by a resource manager of the first computing device, the at least second portion of the updated/created content through a resource type extension as an instance of a resource type.

12. An apparatus comprising:
a processor; and
a computing engine operated by the processor and adapted to
receive, from a first computing device, notification that content has been created and/or updated on the first computing device;
identify one or more other computing devices to receive a notification of the creation/update, to enable the one or more other computing devices and the first computing device to be synchronized with each other with respect to the content; and
transmit the notification of the creation/update to each of the one or more identified other computing devices.

13. The apparatus of claim 12, wherein the computing engine is further adapted to enable a user to define a network of computing devices of the user.

14. The apparatus of claim 13, further comprising a list of all computing devices of the network, and a master combined list of all resources to be synchronized for each computing device, wherein said identifying of one or more other computing devices to receive a notification of the creation/update is based at least in part on contents of the list.

15. The apparatus of claim 13, wherein the computing engine is adapted to enable a user to add a computing device to the user's network of computing devices.

16. The apparatus of claim 13, wherein the computing engine is adapted to enable a user to add a computing device of a second user to the user's network of computing devices as if it were a computing device of the user.

17. The apparatus of claim 12, further comprising programming instructions capable of implementing an agent to facilitate content synchronization operations of the first computing device and the one or more other computing devices, wherein the computing engine is further adapted to download the programming instructions capable of implementing the agent to one of the computing devices.

18. An article of manufacture comprising:
a storage medium; and
a plurality of programming instructions designed to program a first computing device and enable the first computing device to
receive, from a server, a notification that content on a second computing device has been created or updated;
request at least a first portion of the created/updated content from the second computing device to contribute to synchronizing the first and second computing devices with respect to the content; and
receive at least a second portion of the created/updated content from the second computing device to effectuate said contribution to synchronizing the first and second computing devices with respect to the content.

19. The article of claim 18, wherein the programming instructions are further designed to enable the first computing device to
monitor creating and/or updating of content on the first computing device; and
notify the server of creating and/or updating of content on the first computing device.

20. The article of claim 18, wherein the programming instructions are further designed to enable the first computing device to establish a peer-to-peer networking connection between the first computing device and the second computing device to facilitate said request and receive.

21. The article of claim 18, wherein the at least second portion of the updated/created content comprises the differences between an updated file and a previous version of the updated file.

22. The article of claim 18, wherein the programming instructions are further designed to enable the first computing device to, upon receiving notification of the created/updated content, automatically request the at least first portion of the created/updated content from the second computing device.
